(19) United States
(12) Patent Application Publication
(10) Pub. No.: US 2017/0245684 A1
(43) Pub. Date: Aug. 31, 2017

(54) Cooking Utensil With Divider System

(71) Applicant: Abigail Garza, Indio, CA (US)

(72) Inventor: Abigail Garza, Indio, CA (US)

(21) Appl. No.: 15/053,076

(22) Filed: Feb. 25, 2016

(51) Int. Cl. A47J 37/10; B65D 25/04; B65D 25/28; A47J 36/02

(52) U.S. Cl. CPC A47J 37/101; A47J 36/025; B65D 25/04; B65D 25/28

(57) ABSTRACT

The present invention provides a cooking utensil and in particular a frying pan having plurality of compartments. The compartments are formed by separating the inner volume through a divider and preferably a divider running across the center of frying pan which divides the frying pan into substantially two equal halves. The frying pan of present invention is advantageous to allow cooking two dishes at the same time and in a same frying pan without mixing the contents of dish.

### (B) CROSS REFERENCE TO RELATED APPLICATION

Not Applicable

### (C) FEDERALLY SPONSORED RESEARCH AND DEVELOPMENT

Not Applicable

### (D) MICROFICHE APPENDIX

Not Applicable

### (E) BACKGROUND OF THE INVENTION

(1) Field of Invention

The present invention generally relates to cooking utensils and in particular to a frying pan having plurality of compartments.

(2) Background of Invention

It is a common practice to prepare multiple dishes for a meal, particularly in a family where an individual person may prefer a different dish. Two or more dishes could either be prepared one by one or prepared at same time if more than one burner is available. Typically, the number of burners available in a household gas burner is limited or a person may be travelling wherein the person could have access to a single burner. In such a situation, only one dish could be prepared at a time and preparing more than one dish may require significant amount of time and further could become laborious. Thus, a need is appreciated for a device which allows cooking more than one dish on a single burner.

Prior art discloses attempts to overcome the above problem, for example, a published U.S. patent application Ser. No. 12/624,209 discloses a set of pots and pans with a dividing wall that separates the pot or pan into sections which allow for simultaneous cooking of multiple dishes; Another, published U.S. patent application Ser. No. 13/292,779 discloses a pot with a removable divider for separating the pot into compartments and the divider has channels with a seal element for selecting fluid communication between the compartments; Another, U.S. Pat. No. 6,844,529 issued to “Robert L. Grohs” which discloses an electric grill divided into two compartments; Another U.S. Pat. No. 4,817,512 issued to “vangen Sandra K” discloses a deep fryer which includes two or more sections having separate on and off switches to permit the heating of each section individually; Another, U.S. Pat. No. 6,035,766 issued to “Schirmer; Patricia C.” which discloses a pot having multiple compartments separated by a divider wall and each of the compartment having different heating zone; Another, U.S. patent application Ser. No. 09/808,246 discloses a pot with multiple compartments separated by divider and each compartment is sealed, and a lid may be used to cover a portion of the pot; Another, U.S. Pat. No. 8,800,804 issued to “Jason Roben” discloses a pan with grilling at the cooking surface and an insert divides the pan into two halves, inserter having an aperture to allow liquid to flow from one section to another and a lid separable into two halves to cover the pan.

Beside, several types of devices have been disclosed in the prior art, very few devices could have been commercialized due to one or more disadvantages of the prior art devices. Thus, a need is appreciated for an economic and simple to use device which is commercially advantageous.

### (F) BRIEF SUMMARY OF THE INVENTION

The present invention, therefore, has as its principal object to provide a frying pan with plurality of chambers.

Another object of the invention is that the frying pan could be used to cook two dishes at the same time and on a single burner.

Still, another object is that the divider of the frying pan keeps the content of each compartment isolated.

Yet, another object of current invention is that the frying pan is economical to manufacture and simple to use.

Certain embodiments of current invention provide a cooking utensil, in particular a frying pan, wherein the frying pan is divided into more than one compartment by one or more dividers and preferably the frying pan is divided into two compartments. The frying pan could be made in any obvious shape and size, such as, square, rectangular, ellipsoidal, or round.

In addition to the various objects and advantages of the present invention described with some degree of specificity above it should be obvious that additional objects and advantages of the present invention will become more readily apparent to those persons who are skilled in the relevant art from the following more detailed description of the invention.

### (G) BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is the top and side perspective view of the pan with the divider.

FIG. 2 is the pan of FIG. 1 with the lid.

FIG. 3 is the side view of the pan with lid.

FIG. 4 is the side and top perspective with of the lid showing the hinged lid portions.

### (H) DETAIL DESCRIPTION OF THE INVENTION

The present invention provides a cooking utensil i.e. a frying pan with plurality of compartments.

Before explaining at least one embodiment of the invention in detail, it is to be understood that the invention is not limited in its application to the details of construction and the arrangements of the components set forth in the following description. The invention is capable of other embodiments and of being practiced and carried out in various ways. Also it is to be understood that the phraseology and terminology employed herein are for the purpose of description and should not be regarded as limiting.

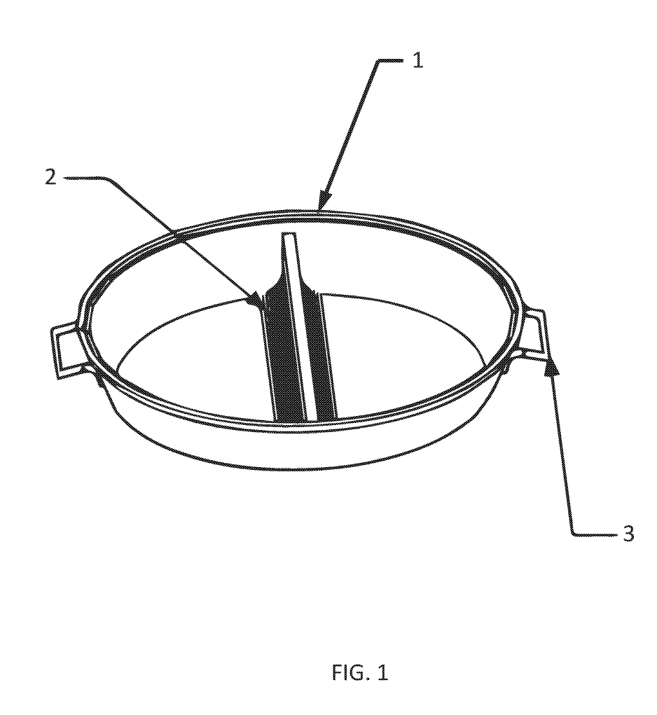

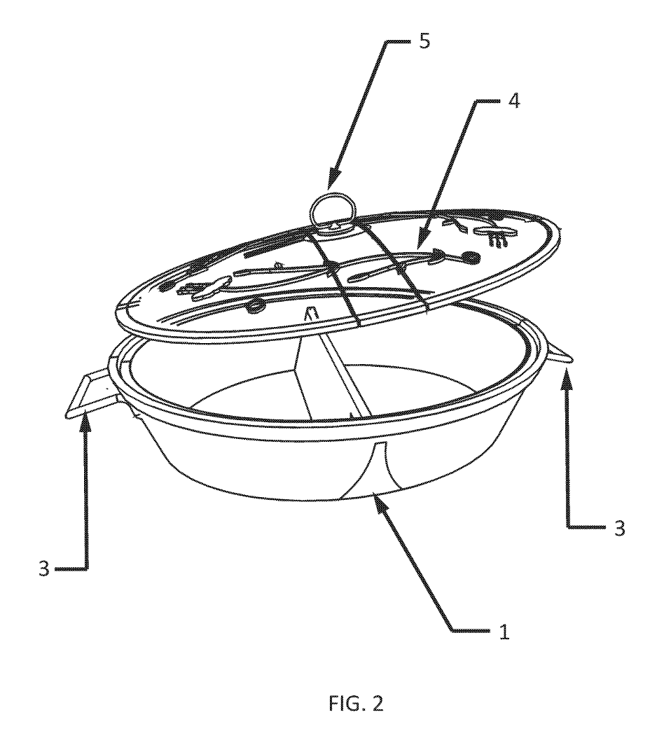

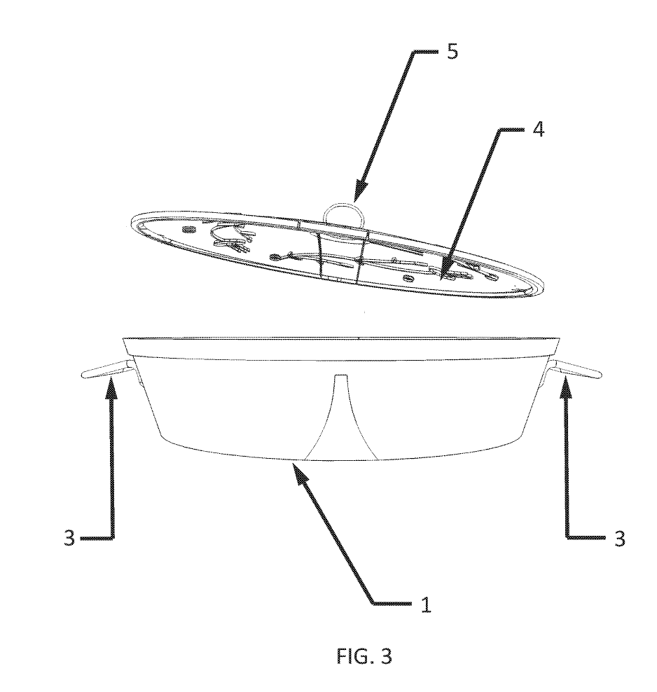

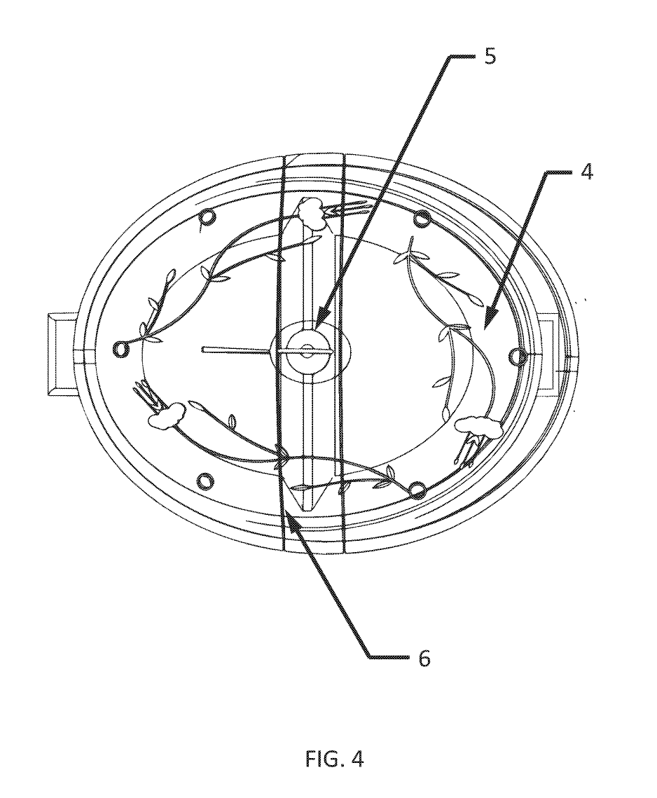

Looking at the figures showing an exemplary embodiment of present invention, which is a frying pan. The FIG. 1 illustrates a frying pan 1 that is divided into two components by a divider 2 which runs across the length of pan and substantially through the center of frying pan which divides the pan substantially into two equal halves. FIG. 2 illustrate the side and top perspective view of the frying pan 1 having a divider 2 and a pair of handles 3. Further is illustrated a lid 4 having a handle 5 in top central portion. FIG. 3 shows the side view of the frying pan 1 with pair of handles 3 and a lid 4 shown in slating position. FIG. 4 illustrate the top view of the lid 4 having a handle at center and further is illustrated an exemplary hinge mechanism 6 dividing the lid in two portions.

The frying pan according to the current invention could be made of any suitable materials ordinary used in the manufacture of cooking utensils, such as, copper, steel, stainless steel, aluminum and like. The frying pan illustrated in the figures has a pair of handles 3 adapted to grip by hands of the user for lifting the frying pan. The handle could be made from same or different material as of the frying pan but should be strong enough to conveniently lift the pan using one hand. Preferably, the handle could have an outer layer of insulated/heat resistant material which may allow convenient handling of pan while cooking or after cooking.

The divider 2 could be made of same material as that of frying pan and could be built while manufacturing the frying pan. The divider is impervious throughout the length of frying pan i.e. the divider separates the individual compartment such that the content of one compartment does not mix with each other. The height of the divider could be similar to the height of the frying pan or it could be made of different heights.

The frying pan 1 could preferably have an inner top layer of a non-sticking material, such as, Teflon or any other material obvious to a skilled person for providing non-sticking properties to cooking utensils. Preferably, the top layer of insulating material covers the divider, thus forming a uniform coat throughout the inner surface of the container. Moreover, the bottom surface of the frying pan could be adapted to absorb more heat by providing circular lines or using any other method obvious to a skilled person for increasing the heat transmission in cooking utensils. Further, the frying pan could optionally have a lid 4 to cover the frying pan wherein the lid could be transparent with a metal rim for viewing the contents within the frying pan. Preferably, the lid 4 could be made of glass with design on top surface for aesthetic appearance. The design could resemble flowers or any other aesthetic figure. A handle 5 is provided on the top center portion of the lid 4 permitting lifting of the lid.

In another embodiment of present invention, the lid 4 has a hinge mechanism 6 dividing the lid 4 into two halves wherein two halves are in juxtaposition to the two halves of frying pan. The hinge mechanism 6 of lid 4 could allow opening only half of the lid 4 while the other compartment is covered by other halve of lid. Furthermore, the lid portion in center could have an extended divider along the hinge line, which could be adapted to urge against the top edge of the divider wall 2 to allow isolating the individual compartment from all sides.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

We claim:

1. A frying pan having at least one divider wherein said divider divides an inner volume of said frying pan into at least two halves.

2. The frying pan of claim 1, wherein said frying pan further has a layer of a non-stick coating on said inner volume, said layer of non-stick coating is continuous to said divider.

3. The frying pan of claim 2, wherein said layer of non-stick coating is a Teflon.

4. The frying pan of claim 1, wherein said frying pan further has a lid.

5. The frying pan of claim 1, wherein said frying pan further has at least one handle adapted to be gripped by a hands for lifting said frying pan.

6. A frying pan having a single divider which passes through center of said frying pan and divides an inner volume of said frying pan substantially into two equal halves.

7. The frying pan of claim 6, wherein said frying pan further has a lid, said lid comprising two lid portions joined by a hinge mechanism to a central lid portion, said two lid portions are in juxtaposition with said two equal halves of said frying pan.
